(19) United States
(12) Patent Application Publication
(10) Pub. No.: US 2014/0264103 A1
(43) Pub. Date: Sep. 18, 2014

(54) Shaped Diaphragm with Retaining Feature

(71) Applicant: WABTEC HOLDING CORP., Wilmerding, PA (US)

(72) Inventors: Andrew F. Pressley, Hendersonville, NC (US); Jeremy R. King, Woodruff, SC (US); Philip J. Marino, Youngwood, PA (US)

(21) Appl. No.: 13/832,915

(22) Filed: Mar. 15, 2013

(51) Int. Cl. F16K 31/126

(52) U.S. Cl. CPC F16K 31/126
USPC 251/61

(57) ABSTRACT

A valve diaphragm for a pneumatic valve includes a diaphragm body having an annular shape defining an inner diameter and an outer diameter. The diaphragm body includes a conical portion extending radially inward from the outer diameter toward the inner diameter and a curved portion extending between the conical portion and the inner diameter.

### BACKGROUND OF THE INVENTION

1. Field of the Invention

The present disclosure relates to a shaped diaphragm for use in a pneumatic valve and, more particularly, to a shaped diaphragm that is formed to have an inherent resilient bias so as to bend in a consistent manner when installed between a valve body and piston assembly of the pneumatic valve.

2. Description of Related Art

Typical pneumatic relay and control valves utilize a diaphragm in a piston-stem assembly as a means to convert a low flow, small volume control pressure into high flow, larger volume output pressure at equivalent or proportionate pressure to that of the control pressure. In a typical application, the control volume on one side of the diaphragm is controlled with a small, low capacity solenoid-type valve. The opposite side of the diaphragm is typically connected to the output pressure through a small feedback port and a force balance is created across the diaphragm when the output pressure is equal (or proportionate) to the control pressure. In these applications, capacity is critical to the functionality of the valve. If the diaphragm does not uniformly “roll” or flex in the desired direction, an inconsistent control volume exists, which, in turn, makes capacity timing inconsistent. Inconsistent control volumes have been commonplace during assembly of these diaphragms due to the inconsistent “roll” when installed. This problem cannot be detected until a technician tests a unit and resolving the problem often requires re-work of an otherwise completed assembly due to unacceptable test results for capacity testing.

In the typical pneumatic valve application, the diaphragm is installed into a machined groove and then clamped with a top plate. The machined groove is designed to interface a diaphragm while the top plate is generally flat and serves to provide a clamp to the diaphragm. The intent of this arrangement is to provide a leak-proof seal without cutting or pinching the diaphragm. During assembly of the top plate to provide the clamping force, the diaphragm is typically pushed in a downward direction, which causes the inner diameter or outer diameter of the diaphragm to expand and oftentimes come out of the machined groove. This often creates problems during testing as well due to pinched or cut diaphragms, or portions of the diaphragm having no clamp at all.

FIGS. 1A-1C illustrate a typical valve diaphragm 10 of the prior art in accordance with the description provided above. The diaphragm 10 includes a diaphragm body 11 having an inner diameter 12 and an outer diameter 13. The diaphragm body 11 includes a single conical portion 14 extending between the inner and outer diameters 12, 13. As discussed above, the diaphragm body 11 is also provided with an inner retaining bead 15 and an outer retaining bead 16 to be clamped to the piston assembly, and between the machined groove and top plate, as discussed above.

As can be appreciated from FIGS. 1A-1C, the diaphragm body 11 is not configured in a manner so as to “roll” or flex in any particular direction during assembly of the valve diaphragm 10 into a pneumatic valve. In particular, when assembled, the diaphragm body 11 may sometimes flex upwards, downwards, or partially in both directions. Further, the inner retaining bead 15 and the outer retaining bead 16 may not be sufficient to keep the diaphragm body 11 from popping out of, or moving out of, the machined grooves into which they are assembled. These features of the prior art valve diaphragm 10 can oftentimes result in inconsistent diaphragm “roll” or flexing that causes many hours of re-work due to capacity problems, which may only be detected during testing of a completed assembly and create problems during assembly with diaphragm pinching and/or insufficient clamping.

### SUMMARY OF THE INVENTION

Accordingly, there is a general need in the art for a valve diaphragm that is configured to “roll” or flex into the proper shape in a consistent manner when installed to create the proper control volume in relay and control valve applications, and includes features to retain the inner diameter and the outer diameter of the diaphragm within the valve assembly.

According to one embodiment, the invention provides a rubber (or other compliant material) diaphragm for use in pneumatic relay or other pneumatic control valves. The diaphragm is of a construction that allows pressurization from air or other gaseous media on both sides of the diaphragm simultaneously. The cross-sectional shape of the diaphragm is such that when the installed position of the diaphragm in a valve assembly is considered, a bias is present to persuade the diaphragm into uniformly “rolling” or flexing in a desired direction. The diaphragm also includes a molded-in bead on both the inside and outside diameters having the shape and geometry to act as a retaining feature for the diaphragm when considering installation into a valve body or piston assembly. The retaining bead design is backwards compatible with existing machined bodies and standard diaphragm clamping arrangements.

One embodiment disclosed in detail herein provides a robust assembly process by controlling how the diaphragm flexes when installed, which determines the control volume created when installed, which, in turn, affects the capacity timing of the valve. The molded-in retaining features enable both the inner diameter and the outer diameter of the diaphragm to be retained for proper and uniform clamping, as well as to prevent pinching. Further, this disclosure allows for the outer diameter of the diaphragm to be seated in a groove in the valve body despite any spring-loading of the piston assembly in the valve body, which may tend to hold the entire piston assembly up outside the valve body.

According to one particular embodiment, a valve diaphragm for a pneumatic valve is provided. The valve diaphragm includes a diaphragm body having an annular shape defining an inner diameter and an outer diameter. The diaphragm body includes a conical portion extending radially inward from the outer diameter toward the inner diameter and a curved portion extending between the conical portion and the inner diameter.

According to another particular embodiment, a pneumatic valve is provided. The pneumatic valve includes a valve body having an exterior surface and at least one chamber defined therein that extends into the valve body from the exterior surface; at least one piston assembly movably disposed in the at least one chamber of the valve body; and at least one valve diaphragm comprising a diaphragm body having an annular shape defining an inner diameter connected to the at least one piston assembly and an outer diameter connected to the exterior surface of the valve body. The diaphragm body includes a conical portion extending radially inward from the outer diameter toward the inner diameter and a curved portion extending between the conical portion and the inner diameter.

Further details and advantages of the various embodiments detailed herein will become clear upon reviewing the following detailed description of the preferred embodiments in conjunction with the accompanying drawing figures.

### BRIEF DESCRIPTION OF THE DRAWINGS

FIG. 1A is a top view of a prior art valve diaphragm;

FIG. 1B is a cross-sectional side view of the prior art valve diaphragm of FIG. 1A taken along line 1B-1B shown in FIG. 1A;

FIG. 1C is a detailed portion of the cross-sectional side view of the prior art valve diaphragm of FIG. 1A;

FIG. 2 is a top view of a pneumatic valve according to one embodiment;

FIG. 3 is a cross-sectional side view of the pneumatic valve of FIG. 2 taken along line 3-3 shown in FIG. 2;

FIG. 4 is a perspective view of a piston assembly and valve diaphragm of the pneumatic valve of FIG. 2;

FIG. 5 is a perspective view of a valve diaphragm of the pneumatic valve of FIG. 2 in accordance with another embodiment;

FIG. 6 is a top view of the valve diaphragm of FIG. 5;

FIG. 7 is a cross-sectional side view of the valve diaphragm of FIG. 5 taken along line 7-7 shown in FIG. 6;

FIG. 8 is a detailed cross-sectional side view of the valve diaphragm of FIGS. 5 and 7; and

FIG. 9 is a detailed cross-sectional side view of the pneumatic valve of FIG. 2 detailing the engagement between the valve body, the piston assembly, and the valve diaphragm in accordance with a further embodiment.

### DETAILED DESCRIPTION OF THE INVENTION

For purposes of the description hereinafter, spatial orientation terms, as used, shall relate to the referenced embodiment as it is oriented in the accompanying drawing figures or otherwise described in the following detailed description. However, it is to be understood that the embodiments described hereinafter may assume many alternative variations and configurations. It is also to be understood that the specific components, devices, and features illustrated in the accompanying drawing figures and described herein are simply exemplary and should not be considered as limiting.

With reference to FIGS. 2-9, a pneumatic valve 100 that includes a shaped valve diaphragm 50 is shown in accordance with one embodiment. As shown in FIGS. 2, 3, and 9, the pneumatic valve 100 includes a valve body 101 having an exterior surface 102 and at least one chamber 103 defined therein that extends into the valve body 101 from the exterior surface 102 such that the at least one chamber 103 is in fluid communication with an exterior of the valve body 101 prior to assembly of the pneumatic valve 100. The valve body 101 also includes a retaining groove 104 defined in the exterior surface 102 and the pneumatic valve 100 also includes a top plate 105. The retaining groove 104 and the top plate 105 are provided for maintaining the engagement between the valve body 101 and the shaped valve diaphragm 50. The top plate 105 may also be provided to define a control volume 120 of the pneumatic valve 100, as will be discussed in further detail below.

The pneumatic valve 100 also includes at least one piston assembly 110. As shown in FIGS. 3, 4, and 9, the piston assembly 110 may include a piston head 111 and a stem 113 depending from the piston head 111. The piston head 111 also includes a circumferential retaining channel 112 defined therein for maintaining the engagement between the piston head 111 and the valve diaphragm 50. The at least one piston assembly 110 is movably disposed within the at least one chamber 103 of the valve body 101. In particular, as shown in FIGS. 3 and 9, the at least one piston assembly 110 is installed into the valve body 101 such that the piston head 111 is at least partially disposed within the at least one chamber 103 of the valve body 101 while the stem 113 is slidably received in the valve body 101 in accordance with principles known to those having ordinary skill in the art. The installed position of the piston head 111 with respect to the valve body 101 is demonstrated by phantom lines shown in FIG. 9. The pneumatic valve 100 also includes at least one valve diaphragm 50 connected to the piston head 111 of the at least one piston assembly 110 and to the exterior surface 102 of the valve body 101.

According to another embodiment, the pneumatic valve 100 includes two corresponding chambers 103, piston assemblies 110, and valve diaphragms 50, though it is to be appreciated that the pneumatic valve 100 may be provided with fewer or more such assemblies depending on the configuration of the pneumatic valve 100 and the operational requirements of the valve 100. Further, as shown in FIG. 2, the exterior surface 102 is shown to be the top surface of the valve body 101, and the piston assembly 110 and the valve diaphragm 50 are oriented upward with respect to the valve body 101. However, it is to be appreciated that the valve body 101 may be configured in a variety of ways such that the piston assembly 110 and the valve diaphragm 50 may be oriented sideways or upside down with respect to the valve body 101. Further, it is to be appreciated that the pneumatic valve 100 may be of any type having a configuration of the type described above with a chamber 103, piston assembly 110, and valve diaphragm 50. According to a particular embodiment, the pneumatic valve 100 is a pneumatic control valve or the pneumatic portion of an electronic relay valve used in connection with a railway car or locomotive.

As shown in FIGS. 5-9, the shaped valve diaphragm 50 includes a diaphragm body 51 having an annular shape defining an inner diameter 52 and an outer diameter 53. In particular, the inner diameter 52 is connected to the piston head 111 of the piston assembly 110, as shown in FIGS. 2-4 and 9, and the outer diameter 53 is connected to the exterior surface 102 of the valve body 101, as shown in FIGS. 2, 3, and 9. According to a particular embodiment, the diaphragm body 51 is molded from a rubber material. However, it is to be appreciated that the diaphragm body 51 may be formed of any suitably compliant material that will bend and flex in the manner described herein.

The diaphragm body 51 includes a conical portion 54 extending radially inward from the outer diameter 53 toward the inner diameter 52 and a curved portion 55 extending radially between the conical portion 54 and the inner diameter 52. The diaphragm body 51 may further include a flat portion 56 that extends radially outward from the inner diameter 52 to the curved portion 55. In an alternative configuration, the flat portion 56 may be replaced with another curved portion having a reverse curvature to the curved portion 55, or the curved portion 55 may extend all the way to the inner diameter 52. The diaphragm body 51 may also further include a second curved portion 57 that extends radially between the conical portion 54 and the outer diameter 53 such that the outer diameter 53 extends radially outward from the end of the conical portion 54 to engage the groove 104 defined in the external surface 102 of the valve body 101, as shown in FIG. 9.

The diaphragm body 51 also includes an interior surface 58 that defines an interior 59 of the diaphragm body 51 and an exterior surface 60 that defines an exterior of the diaphragm body 51. As shown in FIG. 8, the curved portion 55 is curved with a radius R about a center of curvature C defined in the interior 59 of the diaphragm body 51. In other words, the curved portion 55 is formed with a concave curvature with respect to the interior 59 of the diaphragm body 51. As shown in FIGS. 3 and 9, the diaphragm body 51 is oriented with respect to the valve body 101 such that the interior 59 of the diaphragm body 51 is in fluid communication with the at least one chamber 103. In this manner, the interior surface 58 of the diaphragm body 51 is oriented toward an output pressure feedback volume 130 that is at least partially defined by the interior 59 of the diaphragm body 51 and the chamber 103 of the valve body 101. The exterior surface 60 of the diaphragm body 51, meanwhile, is oriented toward a control volume 120 that is at least partially defined by the exterior of the diaphragm body 51 and an exterior of the valve body 101. In other words, the control volume 120 is defined over the diaphragm body 51 and outside of the valve body 101, as shown in FIGS. 3 and 9. As shown in FIG. 9 in accordance with a particular embodiment of the invention, the control volume 120 is defined by the exterior surface 60 of the diaphragm body 51 and the top plate 105, a portion of which is depicted in FIG. 9 with cross-hatching and phantom lines, extending over the exterior surface 102 of the valve body 101, as well as the piston assembly 110 and the valve diaphragm 50. It is to be appreciated, therefore, that the top plate 105 may be a solenoid plate of a pneumatic relay or control valve.

With reference to FIG. 9, the diaphragm body 51 is formed with an internal resilient bias that causes the diaphragm body 51 to flex in a consistent manner, particularly a uniform and unvarying manner, that forms a bent portion B extending “up” from the output pressure feedback volume 130 (or the interior 59 of the diaphragm body 51) toward the control volume 120 (or the exterior of the diaphragm body 51) when the piston assembly 110 is assembled into the valve body 101. When this occurs, the piston head 111 becomes at least partially disposed within the chamber 103 such that the inner diameter 52 of the diaphragm body 51 comes to be disposed vertically adjacent to the outer diameter 53 of the diaphragm body 51 in the sense that the inner diameter 52 is pressed by the piston head 111 in a direction toward the level of the outer diameter 53, thus causing the diaphragm body 51 to flex or “roll” in the manner discussed below. This particular configuration of the piston head 111 and the diaphragm body 51 at the installed height with respect to the valve body 101 is shown in phantom lines in FIG. 9 juxtaposed with the configuration of the piston head 111 and the diaphragm body 51 at the piston assembly free height with respect to the valve body 101 shown in solid lines. It is to be appreciated that the installed height of the piston head 111 and the inner diameter 52 of the diaphragm body 51 may be varied with respect to the valve body 101 such that inner diameter 52 of the diaphragm body 51 is “vertically” spaced from the outer diameter 53 to a greater degree than shown in FIG. 9 or such that the inner diameter 52 and the outer diameter 53 are fully aligned. The terms “vertically adjacent” and “adjacent” as used herein throughout this specification are intended to encompass all such variations in the position of the inner diameter 52 of the diaphragm body 51 with respect to the outer diameter 53 so long as the inner diameter 52 is pressed in the direction toward the outer diameter 53 so as to cause the diaphragm body 51 to flex or “roll” in the manner described below.

As shown in FIG. 9, the diaphragm body 51 is formed with the internal resilient bias, particularly caused by the shaped configuration of the conical portion 54 and the curved portion 55 of the diaphragm body 51, which ensures that the diaphragm body 51 “rolls” or flexes into the proper shape, i.e., forms the bent portion B, when installed in order to create the proper control volume 120 in relay and control valve operations. In other words, the cross-sectional shape of the diaphragm body 51 is configured such that the diaphragm body 51 will consistently, or always, flex or “roll” in the same fashion towards the control volume 120 when installed so that the control volume 120 is uniformly defined and can be accurately determined among a plurality of pneumatic valves 100 without resorting to disassembly of the pneumatic valve 100 to determine the condition of the valve diaphragm 50.

With further reference to FIGS. 3 and 5-9, the diaphragm body 51 further includes a retaining bead 61 formed at the inner diameter 52. Likewise, the diaphragm body 51 also includes a retaining bead 62 formed at the outer diameter 53. According to a particular embodiment, the inner retaining bead 61 and the outer retaining bead 62 have the same shape or geometric configuration. The retaining bead 61 at the inner diameter 52 is disposed within the retaining channel 112 formed in the piston head 111 of the piston assembly 110 in order to maintain the engagement between the inner diameter 52 of the diaphragm body 51 and the piston head 111.

The retaining bead 62 at the outer diameter 53 is disposed within the retaining groove 104 formed in the exterior surface 102 of the valve body 101. As shown in FIG. 9, the top plate 105 can be extended toward the exterior surface 102 of the valve body 101 to engage and/or attach to the exterior surface 102 over the groove 104 and the retaining bead 62 at the outer diameter 53 of the diaphragm body 51 in order to clamp the retaining bead 62 within the retaining groove 104. Accordingly, the retaining bead 62 at the outer diameter 53 is disposed within the retaining groove 104 and clamped by the top plate 105 in order to maintain the engagement between the outer diameter 53 of the diaphragm body 51 and the valve body 101.

Accordingly, the inner retaining bead 61 and the outer retaining bead 62 provide molded-in retaining features to the diaphragm body 51 that ensure that both the inner diameter 52 and the outer diameter 53 of the diaphragm body 51 are properly engaged with the piston head 111 and the valve body 101, and ensure proper and uniform clamping as well as to prevent pinching of the diaphragm body 51 due to the diaphragm body 51 popping out of the retaining channel 112 in the piston head 111 or the retaining groove 104 in the exterior surface 102 of the valve body 101. To that end, the inner retaining bead 61 and the outer retaining bead 62 may include respective semicircular protrusions 63, 64 formed thereon. The semicircular protrusions 63, 64 will tend to be compressed when engaged by the piston head 111 or the plate 105 so as to further clamp the inner retaining bead 61 within the retaining channel 112 and the outer retaining bead 62 between the retaining groove 104 and the plate 105.

Further, the outer retaining bead 62 may be configured with a greater surface area at an outer face 65 of the retaining bead 62 and may also be configured to substantially fill the retaining groove 104. This geometry coupled with a slight interference dimensioning scheme between the outer retaining bead 62 and the retaining groove 104 creates additional friction between the outer face 65 of the outer retaining bead 62 and the mating wall of the retaining groove 104, and retains the diaphragm body 51 within the groove 104 as the piston assembly 110 is pushed into the chamber 103 of the valve body 101 during assembly of the pneumatic valve 100 and fastening of the top plate 105 to the valve body 101. Further, the outer retaining bead 62 may be formed with a thickness T (shown in FIG. 8), including the semicircular protrusion 64, which conforms to the thickness of retaining grooves 104 of existing valve bodies 101 in order to ensure that the outer retaining bead 62 is properly clamped when the valve diaphragm 50 is installed on a pneumatic valve 100 manufactured according to current design standards. In other words, the outer retaining bead 62 is designed to ensure that the valve diaphragm 50 is backwards compatible with existing pneumatic valves 100. It is to be appreciated that a similar geometry may be provided to the inner retaining bead 61 of the diaphragm body 51 as well.

In accordance with yet another particular embodiment, the valve diaphragm 50 is formed with a molded diaphragm body 51 of rubber or similar compliant material. The diaphragm body 51, including the conical portion 54, curved portion 55, flat portion 56, second curved portion 57, inner retaining bead 61, and outer retaining bead 62, may be molded as a single integral, continuous, and monolithic piece. It is to be appreciated, however, that the valve diaphragm 50 may be formed according to a variety of techniques and methods. For instance, the various portions of the diaphragm body 51 may be separately formed and then assembled by fasteners or adhesives or integrated via welding or similar techniques. Or portions of the diaphragm body 51 may be co-molded of different materials or in different stages according to methods and techniques known to those of ordinary skill in the art.

While embodiments of a shaped valve diaphragm for a pneumatic valve were provided in the foregoing description, those skilled in the art may make modifications and alterations to these embodiments without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. A valve diaphragm for a pneumatic valve, comprising:
a diaphragm body having an annular shape defining an inner diameter and an outer diameter,
wherein the diaphragm body includes a conical portion extending radially inward from the outer diameter toward the inner diameter and a curved portion extending between the conical portion and the inner diameter.

2. The valve diaphragm according to claim 1, wherein the diaphragm body is formed with an internal resilient bias that causes the diaphragm body to flex in a consistent manner when the inner diameter and the outer diameter are disposed adjacent to each other.

3. The valve diaphragm according to claim 1, wherein the diaphragm body is comprised of a rubber material.

4. The valve diaphragm according to claim 1, wherein the diaphragm body further includes a flat portion extending radially outward from the inner diameter to the curved portion.

5. The valve diaphragm according to claim 1, wherein the diaphragm body further includes a second curved portion extending radially between the conical portion and the outer diameter.

6. The valve diaphragm according to claim 1, wherein the diaphragm body has an interior surface defining an interior of the diaphragm body and an exterior surface defining an exterior of the diaphragm body, and wherein the curved portion is curved with a radius about a center disposed in the interior of the diaphragm body.

7. The valve diaphragm according to claim 6, wherein the diaphragm body is formed with an internal resilient bias that causes the diaphragm body to flex in a consistent manner that forms a bent portion extending from the interior and towards the exterior when the inner diameter and the outer diameter are disposed adjacent to each other.

8. The valve diaphragm according to claim 1, wherein the diaphragm body further includes a retaining bead formed at the inner diameter.

9. The valve diaphragm according to claim 1, wherein the diaphragm body further includes a retaining bead formed at the outer diameter.

10. The valve diaphragm according to claim 1, wherein the diaphragm body further includes retaining beads formed at the inner diameter and the outer diameter, respectively, and wherein the retaining beads have the same shape.

11. A pneumatic valve, comprising:
a valve body having an exterior surface and at least one chamber defined therein that extends into the valve body from the exterior surface;
at least one piston assembly movably disposed in the at least one chamber of the valve body; and
at least one valve diaphragm comprising a diaphragm body having an annular shape defining an inner diameter connected to the at least one piston assembly and an outer diameter connected to the exterior surface of the valve body,
wherein the diaphragm body includes a conical portion extending radially inward from the outer diameter toward the inner diameter and a curved portion extending between the conical portion and the inner diameter.

12. The pneumatic valve according to claim 11, wherein the diaphragm body is formed with an internal resilient bias that causes the diaphragm body to flex in a consistent manner when the piston assembly is assembled in the valve body and the inner diameter and the outer diameter of the diaphragm body are disposed adjacent to each other.

13. The pneumatic valve according to claim 11, wherein the diaphragm body is comprised of a rubber material.

14. The pneumatic valve according to claim 11, wherein the diaphragm body further includes a flat portion extending radially outward from the inner diameter to the curved portion.

15. The pneumatic valve according to claim 11, wherein the diaphragm body further includes a second curved portion extending radially between the conical portion and the outer diameter.

16. The pneumatic valve according to claim 11, wherein
the diaphragm body has an interior surface defining an interior of the diaphragm body and an exterior surface defining an exterior of the diaphragm body,
the curved portion of the diaphragm body is curved with a radius about a center disposed in the interior of the diaphragm body, and
the diaphragm body is oriented with respect to the valve body such that the interior of the diaphragm body is in fluid communication with the at least one chamber.

17. The pneumatic valve according to claim 16, wherein
the interior surface of the diaphragm body is oriented toward an output pressure feedback volume at least partially defined by the interior of the diaphragm body and the at least one chamber of the valve body,
the exterior surface of the diaphragm body is oriented toward a control volume at least partially defined by the exterior of the diaphragm body and outside of the valve body, and
the diaphragm body is formed within an internal resilient bias that causes the diaphragm body to flex in a consistent manner that forms a bent portion extending from the output pressure feedback volume toward the control volume when the piston assembly is assembled in the valve body and the inner diameter and the outer diameter of the diaphragm body are disposed adjacent to each other.

18. The pneumatic valve according to claim 11, wherein
the diaphragm body further includes a retaining bead formed at the inner diameter, and
the retaining bead at the inner diameter is disposed within a circumferential channel defined in a piston head of the piston assembly.

19. The pneumatic valve according to claim 11, wherein the diaphragm body further includes a retaining bead formed at the outer diameter, and
wherein the retaining bead at the outer diameter is disposed within a retaining groove formed in the exterior surface of the valve body.

20. The pneumatic valve according to claim 19, further comprising a plate attached to the exterior surface of the valve body and clamping the retaining bead at the outer diameter within the retaining groove.
